(19) United States
(12) Patent Application Publication
(10) Pub. No.: US 2012/0001895 A1
(43) Pub. Date: Jan. 5, 2012

(54) LIGHT MODULE AND DISPLAY APPARATUS USING THE SAME

(76) Inventor: Chi-Hsin LIN, Taipei County (TW)

(21) Appl. No.: 12/827,532

(22) Filed: Jun. 30, 2010

(51) Int. Cl. G06F 3/038; H05B 37/02

(52) U.S. Cl. 345/214; 315/312

(57) ABSTRACT

A light module is applied to a display apparatus. The light module includes a plurality of light units. Each of the light units has a circuit board, a plurality of control driving units, and a plurality of light-emitting diodes. The circuit board is divided into a plurality of circuit blocks electrically connected each other. The amount of the control driving units is the same as that of the circuit blocks and the control driving units are disposed in the circuit blocks, respectively. The light-emitting diodes are disposed in the circuit blocks and electrically connected to the control driving units, respectively.

### BACKGROUND OF THE INVENTION

1. Field of the Invention

The present invention relates to a display apparatus, and more particularly to a display apparatus with light-emitting diodes as a light source.

2. Description of Prior Art

Reference is made to FIG. 1 which is a circuit diagram of a prior art display module. The display apparatus includes a control driving unit 10 and a plurality of light strings 20. More particularly, each of the light strings 20 has a plurality of light-emitting diodes 22. The control driving unit 10 is electrically connected to the light strings 20 to provide a driving signal to drive the light strings 20 and produce a control signal to control brightness variations of the light-emitting diodes 22.

However, the above-mentioned display apparatus provides only one control driving unit 10 to drive the light strings 20, thus this will result in more complicated circuit layout. In addition, because the lifetime of the light-emitting diode 22 is longer than that of the control driving unit 10, the display apparatus malfunctions when the control driving units 10 are damaged.

Furthermore, because one light string 20 has a plurality of light-emitting diodes 22, the light strings 20 (including the undamaged light strings 20) would be replaced as any one light-emitting diode 22 is damaged. Accordingly, this will influence display effect and significantly increase costs of the display apparatus.

### SUMMARY OF THE INVENTION

In view of the foregoing prior art, one object of the present invention is to provide a light module.

The other object of the present invention is to provide a display apparatus using the light module.

In order to achieve the above-mentioned objects, a light module is disclosed. The light module includes a plurality of light units. Each of the light units has a circuit board, a plurality of control driving units, a plurality of light-emitting diodes. The circuit board is divided into a plurality of circuit blocks electrically connected each other. The amount of the control driving units is the same as that of the circuit blocks and the control driving units are disposed in the circuit blocks, respectively. The light-emitting diodes are disposed in the circuit blocks and electrically connected to the control driving units, respectively.

In addition, the present invention provides a display apparatus. The display apparatus includes a back plate, a plurality of light modules, and a semi-transparent cover plate.

The light modules are disposed on the back plate, and each of the light modules has a plurality of light units. Each of the light units has a circuit board, a plurality of control driving units, and a plurality of light-emitting diodes. The circuit board is divided into a plurality of circuit blocks electrically connected each other. The amount of the control driving units is the same as that of the circuit blocks and the control driving units are disposed in the circuit blocks, respectively. The light-emitting diodes are disposed in the circuit blocks and electrically connected to the control driving units, respectively. The semi-transparent cover plate is covered above the light modules.

Accordingly, the present invention provides the light units electrically connected each other to form a large flat surface for light emitting. More particularly, the user can easily replace the damaged light units to completely display the desired characters or images when any one of the light units is damaged.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a prior art LED light module;

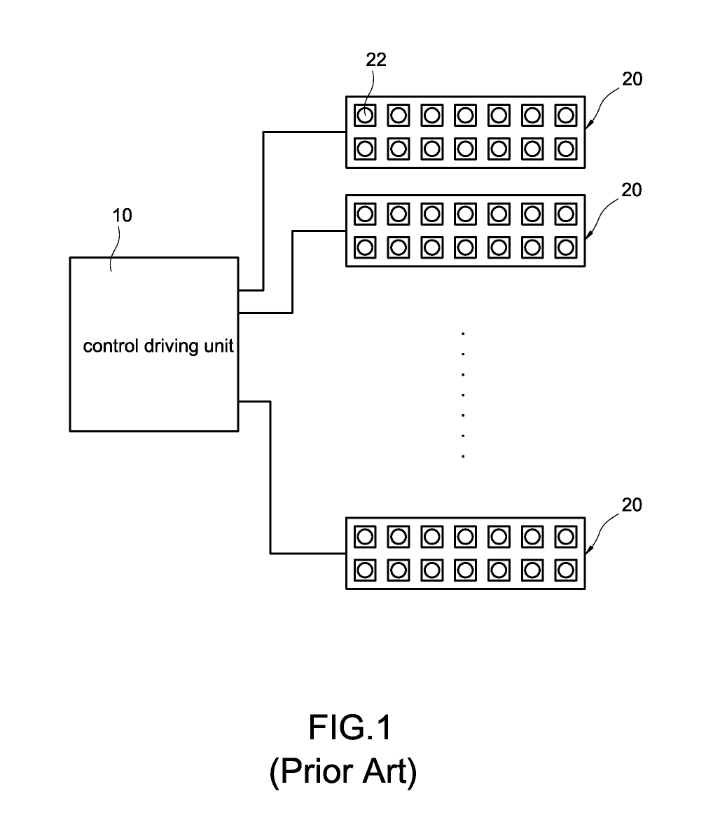

FIG. 2 is a perspective view of a light module according to the present invention;

FIG. 3 is a schematic view of installing the light module and a connecting unit;

FIG. 4 is a schematic view of replacing a circuit block of the light module;

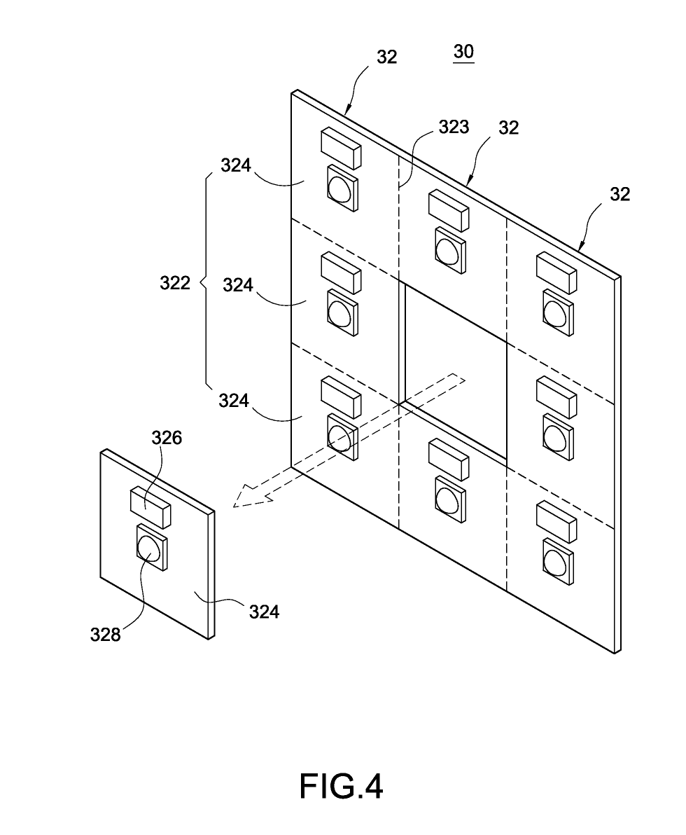

FIG. 5 is an exploded perspective view of a display apparatus;

FIG. 6 is a cross-sectional view of the display apparatus; and

FIG. 7 is a perspective view of an embodiment of the display apparatus.

### DETAILED DESCRIPTION OF THE INVENTION

Reference will now be made to the drawing figures to describe the present invention in detail.

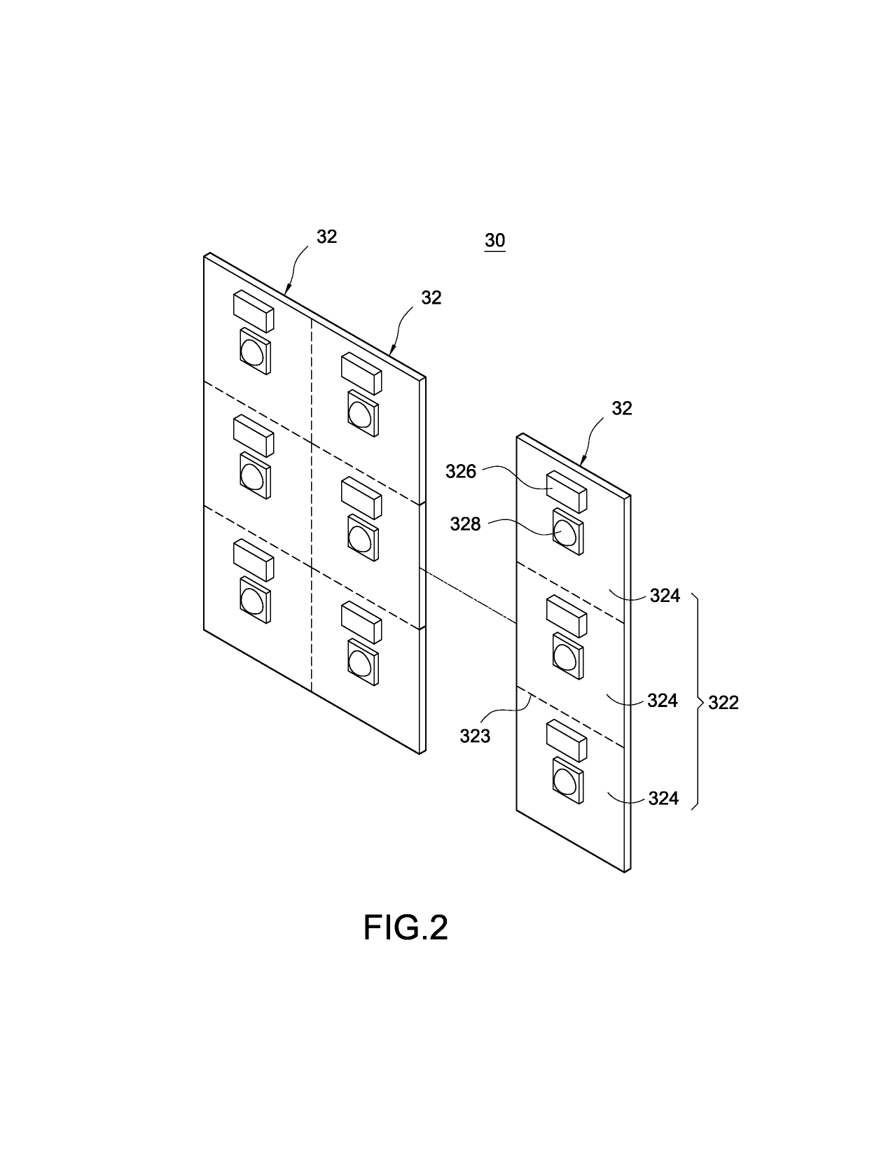

The present invention relates to a light module, and the light module is applied to a display apparatus. The light module 30 includes a light unit 32 extended along a predetermined direction. The light unit 32 has a circuit board 322, a plurality of control driving unit 326, and a plurality of light-emitting diodes 328. Reference is made to FIG. 2 which is a perspective view of a light module according to the present invention. A plurality of textures 323 are arranged on a surface of the circuit board 322 so that the circuit board 322 is divided into a plurality of equal-sized circuit blocks 324 electrically connected each other. Each of the circuit blocks 324 has a control driving unit 326 and at least one light-emitting diode 328. More particularly, the control driving units 326 and the light-emitting diodes 328 are disposed on the same side of the circuit board 322. Alternatively, the light-emitting diodes 328 can be disposed on the opposite sides of the circuit board 322.

Each of the circuit board 322 has copper foil layouts (not shown) disposed on a surface thereof, and the layout manners of the copper foil layouts are the same. The copper foil layouts are used to provide transmission paths of power signals and control signals of the adjacent circuit blocks 324. More particularly, the circuit blocks 324 are of regular triangle shape, regular square shape, or other regular polygon shape. In this example, the regular-squared circuit blocks 324 are exemplified for further demonstration.

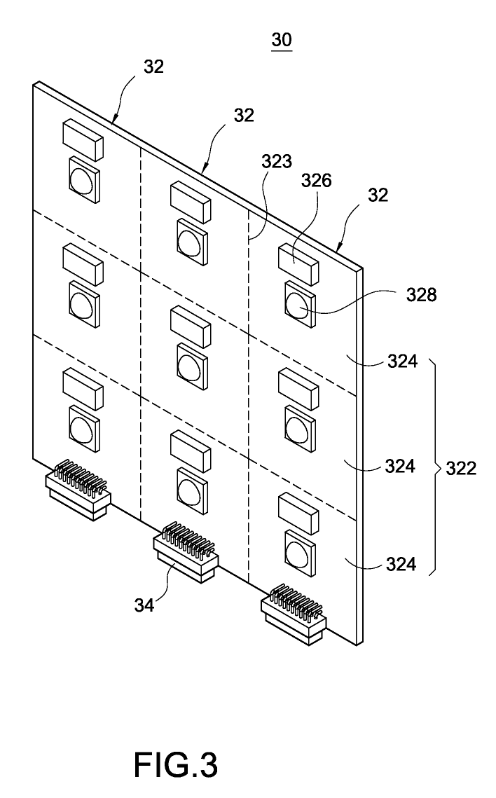

The amount of the control driving units 326 is the same as that of the circuit blocks 324 and the control driving units are disposed in the circuit blocks, respectively. The control driving units 326 are electrically connected to the copper foil layouts of the circuit blocks 324. The control driving units 326 are used to provide a driving signal to drive the light-emitting diodes 328 and produce a control signal to control brightness variations of the light-emitting diodes 328. More particularly, the driving signal and the control signal are sent along a predetermined direction of the circuit board 322. Users can operate an external host (not shown) to control the control driving units 326, thus driving the light-emitting diodes 328 to display the desired characters or images. Accordingly, a connecting unit 34 is connected to one end of the circuit board 322 of each light unit 32. Reference is made to FIG. 3 which is a schematic view of installing the light module and a connecting unit. The connecting unit 34 is electrically connected to the light unit 32 and the external host to receive the driving signal and the control signal of the light unit 32. More particularly, the connecting unit 34 can be a conductive wire, electrical connector, or a wireless receiver.

The light-emitting diodes 328 are electrically connected to the control driving units 326, and the light-emitting diodes are disposed in the circuit blocks 324, respectively. More particularly, each of the light-emitting diodes 328 has red, green, and blue light emitting diode chips to provide various color variations of the light modules 30. In a practical application, however, each of the light-emitting diodes 328 can provide only one or two colors among the above-mentioned colors.

More particularly, the light module 30 is composed of a plurality of light units 32. Each of the light units 32 has a plurality of circuit blocks 324, a plurality of control driving units 326, and at least one light-emitting diode 328. The amount of the control driving units 326 is the same as that of the circuit blocks 324. The light-emitting diode 328 is disposed on each circuit block 324. In addition, each of the circuit blocks 324 has copper foil layouts disposed on a surface thereof, and the layout manners of the copper foil layouts are the same. The copper foil layouts are used to provide transmission paths of power signals and control signals of the adjacent circuit blocks 324 so as to simplify the circuit layouts of the light modules 30.

The user can easily take out the damaged control driving units 326 or the circuit blocks 324 by a cutting tool and replace new undamaged thereof when any one of the control driving units 326 or light-emitting diodes 328 is damaged. Furthermore, a conductive paste, such as a silver paste, or a solder is used to be a medium for electrically connecting the adjacent circuit blocks 324. Accordingly, this can overcome the problems of the prior art display apparatus to significantly increase the use convenience and effectively save costs.

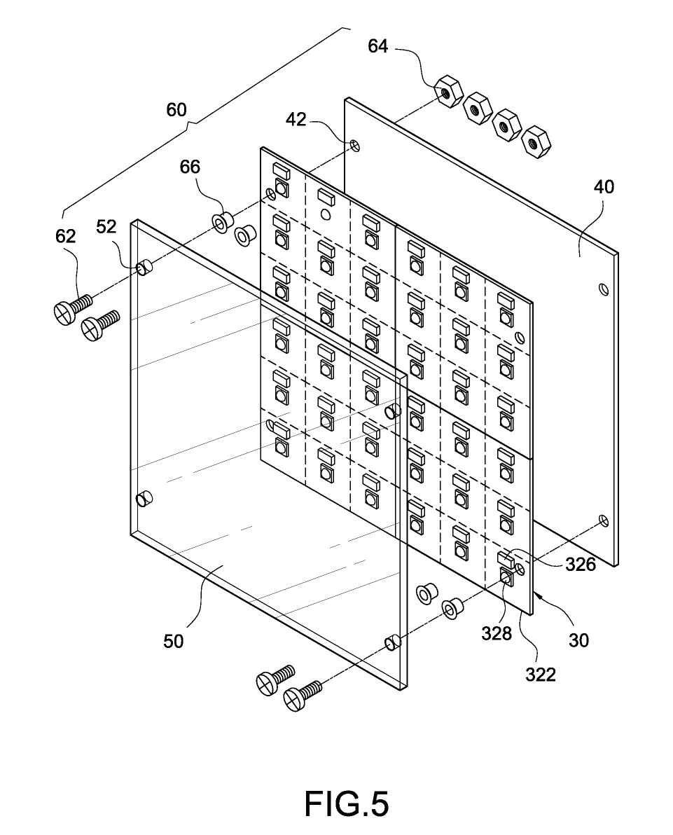

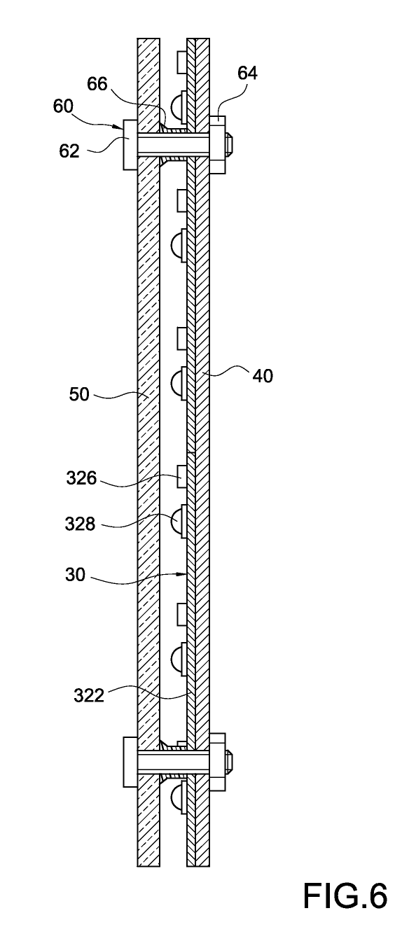

Reference is made to FIG. 5 and FIG. 6 which are an exploded perspective view of a display apparatus and a cross-sectional view of the display apparatus, respectively. The display apparatus includes a back plate 40, a plurality of light modules 30, a semi-transparent cover plate 50, and a plurality of fixed elements 60. The back plate 40 has a plurality of perforatings 42 thereon. The back plate 40 is a major supporting structure of the display apparatus and further provides other functions, such as EMI shielding, heat dissipating, and temperature uniforming.

The light modules 30 are disposed on the back plate 40. Each of the light modules 30 has a plurality of light units 32. Each of the light units 32 has a circuit board 322, a plurality of control driving units 326, and a plurality of light-emitting diodes 328. The light units 32 are extended along a predetermined direction (as shown in FIG. 2), and the power signals and the control signals of the light units 32 are transmitted along the predetermined direction.

The light modules 30 can be collocated in different forms, such as a rectangle-shaped form, according to user demands. When the light modules 30 are collocated, adjacent light modules 30 and the corresponding light units 32 are extended along the same direction. In addition, a conductive paste is used to be a medium for electrically connecting the adjacent light units 32, thus conducting power signals and control signals between the light units 32. More particularly, the user can set parameters of the control driving units 326 to display the desired characters or images.

The semi-transparent cover plate 50 is disposed above the light modules 30, and the semi-transparent cover plate 50 has a plurality of through holes 52 which are corresponding to the perforatings 42. The semi-transparent cover plate 50 is used to effectively avoid outside dust being adhered on the light modules 30, thus preventing the light modules 30 being short circuited and resulting in the non-uniform brightness of the light-emitting diodes 328. More particularly, the semi-transparent cover plate 50 is a reflective glass.

Each of the fixed elements 60 has a plurality of screws 62, a plurality of nuts 64, and a plurality of supporting elements 66. The screws 62 penetrate through the through holes 52, the supporting elements 66, and the perforatings 42, and lock to the nuts 64. The supporting elements 66 are used to avoid the semi-transparent cover plate 50 from directly pressing on the light modules 30, thus preventing the control driving units 326 and the light-emitting diodes 328 being damaged.

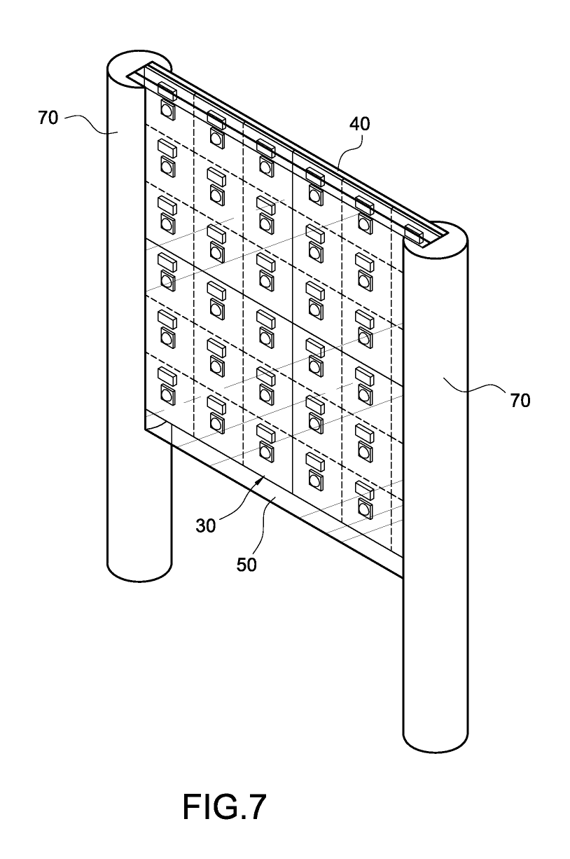

Reference is made to FIG. 7 which is a perspective view of an embodiment of the display apparatus. Two supporting columns 70 are used to provide supporting means for the display apparatus with predetermined height, thus increasing flexibility of operating the display apparatus. In addition, the display apparatus further can be locked on the ceiling or fixed on the wall. Furthermore, the display apparatus can provide different display facings, such as a double-side, a triple-side, or even a multiple-side facing by varying placement position of the back plate 40 and the light modules 30, thus providing a multi-aspect vision (even including different display contents which can be set by the use) of the display apparatus.

According to the above-mentioned description, the display apparatus uses the light modules 30 (which have the control driving unit 326 and the light-emitting diodes 328) electrically connected each other to form a large flat surface for light emitting. More particularly, each of the light modules 30 has a plurality of light units 32, and each of the light units 32 has a plurality of circuit blocks 324. Each of the circuit blocks 324 has a control driving unit 326 and at least one light-emitting diode 328. The user can easily replace the damaged control driving units 326 or the circuit blocks 324 of the light-emitting diodes 328 when any one of the control driving units 326 or the light-emitting diodes 328 is damaged. Accordingly, this can overcome the problems of the prior art display apparatus to significantly increase the use convenience and effectively save costs.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light module, comprising:
a plurality of light unit, and each of the light unit having:
a circuit board divided into a plurality of circuit blocks electrically connected each other;
a plurality of control driving units, and the amount of the control driving units is the same as that of the circuit blocks and the control driving units are disposed in the circuit blocks, respectively; and
a plurality of light-emitting diodes disposed in the circuit blocks and electrically connected to the control driving unit.

2. The light module in claim 1, wherein each of the light unit further has a connecting unit disposed one side of the circuit board and electrically connected to the light unit.

3. The light module in claim 1, wherein each of the circuit board has a plurality of textures arranged on a surface thereof for dividing the circuit board into a plurality of equal-sized circuit blocks electrically connected each other.

4. The light module in claim 1, wherein each of the circuit board has copper foil layouts disposed on a surface thereof, and the layout manners of the copper foil layouts are the same.

5. The light module in claim 1, wherein the circuit blocks are of regular polygon shape.

6. The light module in claim 1, wherein each of the light-emitting diodes has red, green, and blue color light emitting diode chips.

7. The light module in claim 1, wherein each of the circuit blocks has at least one light-emitting diode.

8. The light module in claim 1, wherein the control driving units and the light-emitting diodes are disposed on the same side of the circuit board.

9. The light module in claim 1, wherein the control driving units and the light-emitting diodes are disposed on the opposite sides of the circuit board.

10. A display apparatus, comprising:
a back plate;
a plurality of light modules disposed on the back plate, and each of the light modules having a plurality of light units; and each of the light units having:
a circuit board divided into a plurality of circuit blocks electrically connected each other;
a plurality of control driving units, and the amount of the control driving units is the same as that of the circuit blocks and the control driving units are disposed in the circuit blocks, respectively; and
a plurality of light-emitting diodes disposed in the circuit blocks and electrically connected to the control driving unit; and
a semi-transparent cover plate covered above the light modules.

11. The display apparatus in claim 10, further comprising a plurality of fixed elements provided to lock the back plate, the light modules, and the semi-transparent cover plate.

12. The display apparatus in claim 11, further comprising a supporting element disposed between the light modules and the semi-transparent cover plate.

13. The display apparatus in claim 10, wherein each of the light units further has a connecting unit disposed on one side of the circuit board and electrically connected to the light unit.

14. The display apparatus in claim 10, wherein each of the circuit board has a plurality of textures arranged on a surface thereof for dividing the circuit board into a plurality of equal-sized circuit blocks electrically connected each other.

15. The display apparatus in claim 10, wherein each of the circuit board has copper foil layouts disposed on a surface thereof, and the layout manners of the copper foil layouts are the same.

16. The display apparatus in claim 10, wherein the circuit blocks are of regular polygon shape.

17. The display apparatus in claim 1, wherein each of the circuit blocks has at least one light-emitting diode.

18. The display apparatus in claim 10, wherein the control driving units and the light-emitting diodes are disposed on the same side of the circuit board.

19. The display apparatus in claim 10, wherein the control driving units and the light-emitting diodes are disposed on the circuit board.

20. The display apparatus in claim 10, wherein the semi-transparent cover plate is a reflective glass.
